(19) United States
(12) Patent Application Publication
(10) Pub. No.: US 2023/0049282 A1
(43) Pub. Date: Feb. 16, 2023

(54) FROZEN FOOD

(71) Applicant: IKEDA FOOD RESEARCH CO., LTD., Hiroshima (JP)

(72) Inventors: Takeshi MOROSUGI, Saitama (JP); Akiomi OKADA, Saitama (JP)

(73) Assignee: IKEDA FOOD RESEARCH CO., LTD., Hiroshima (JP)

(21) Appl. No.: 17/399,394

(22) Filed: Aug. 11, 2021

(51) Int. Cl. A23L 7/109; A23L 3/36; A23L 23/00; A23L 5/10; B65D 81/34

(52) U.S. Cl. CPC A23L 7/111; A23L 3/36; A23L 23/00; A23L 5/15; B65D 81/3446; A23V 2002/00; B65D 2581/3404; B65D 2581/3437

(57) ABSTRACT

A frozen food is provided that requires neither addition of water nor large cookware such as a pot, an electromagnetic cooker and a gas stove; is easy to eat; can be stored for a long period; does not cause loosening and uneven heating of the noodle; and makes it possible to enjoy an aromatic and authentic taste in a simple manner only by heating in a microwave oven. It was found that a plurality of chunks of frozen soup having a specific size are placed at a higher position with respect to a frozen noodle, so that a frozen food that makes it possible to enjoy an authentic taste as a hot noodle simply by microwave cooking can be provided, and these findings have led to the present invention.

### TECHNICAL FIELD

The present invention relates to a frozen food for microwave cooking and to a method for eating a frozen food.

### BACKGROUND ART

Since frozen foods are easy to eat by microwave cooking and can be stored for a long period without preservatives, a wide variety of frozen foods are sold. Recently, there has been an increase in the number of convenient and simple authentic frozen foods that make it possible to enjoy authentic taste without going to a restaurant.

For example, Patent Document 1 discloses, as a food for enjoying an authentic noodle including authentic ingredients with no labor, a frozen noodle or rice with ingredients in a food container, which can be eaten simply by addition of water or hot water and microwave cooking, and characteristically contains 1.5 to 15 time-concentrated frozen soup, the frozen boiled noodle or rice, and 70 to 200 parts by weight of ingredients based on 100 parts by weight of the noodle or rice, in this order from a bottom of the food container.

### PRIOR ART DOCUMENTS

### Patent Documents

Patent Document 1: Japanese Patent No. 6296812

### SUMMARY OF INVENTION

### Problem to be Solved

Frozen foods using concentrated frozen soup have had problems that aromatic soup cannot be tasted at the time of eating because aromatic components volatilize at a concentration stage, and that water is required at the time of eating. In addition, frozen foods to be eaten as hot noodles have had problems that a frozen food using plate-shaped frozen soup does not require addition of water but requires cookware such as a pot at the time of eating, and if a microwave oven is used instead of the pot, the noodle loosens and uneven heating is caused. A frozen food is provided that requires neither addition of water at the time of eating nor large cookware such as a pot, an electromagnetic cooker and a gas stove; can be eaten by simple cooking; can be stored for a long period; is hard to cause loosening and uneven heating of the noodle; and makes it possible to enjoy an aromatic and authentic taste in a simple manner only by heating in a microwave oven.

### Solution to Problem

As a result of investigations to solve the above problems, the inventors have found that a plurality of chunks of frozen soup having a specific size are placed at a higher position with respect to a frozen noodle, so that a frozen food that makes it possible to enjoy an authentic taste as a hot noodle simply by microwave cooking can be provided, and these findings have led to the present invention.

That means, the present invention relates to the following aspects [1] to [8].

[1] A frozen food for microwave cooking, in which a plurality of chunks of frozen soup of 5 g or more and 80 g or less per chunk are placed above a frozen noodle and the frozen food is heated in a microwave oven for eating.
[2] The frozen food according to [1], which is a frozen food in a food container (a container for eating) in which the plurality of chunks of frozen soup of 5 g or more and 80 g or less per chunk are arranged above the frozen noodle.
[3] The frozen food according to [1] or [2], in which the soup is non-concentrated soup.
[4] The frozen food according to any one of [1] to [3], in which the soup has an oil content of 20% by weight or less.
[5] The frozen food according to any one of [1] to [4], in which the soup has a viscosity of 1.8 Pa·s or lower at 20° C.
[6] The frozen food according to any one of [1] to [5], which can be eaten as a hot noodle without uneven heating by microwave cooking.
[7] A method for eating a frozen food, comprising: placing a plurality of chunks of frozen soup of 5 g or more and 80 g or less per chunk above a frozen noodle; and heating the frozen soup and the frozen noodle in a microwave oven to eat as a hot noodle.
[8] A method for cooking a hot noodle, comprising: placing a plurality of chunks of frozen soup of 5 g or more and 80 g or less per chunk above a frozen noodle; and heating the frozen soup and the frozen noodle in a microwave oven.

### Effects of Invention

The present invention makes it possible to eat a noodle by simple cooking without addition of water at the time of eating and without any large cookware such as a pot, a electromagnetic cooker, and a gas stove. In addition, the present invention makes it possible to enjoy an aromatic and authentic noodle without going to a restaurant and in a simple manner only by heating in a microwave oven. It can be stored for a long period and is hard to cause loosening and uneven heating of the noodle.

### BRIEF DESCRIPTION OF DRAWINGS

FIG. 1 is a vertical sectional view illustrating an example of a frozen food according to the present invention, packaged in a bag.

FIG. 2 is a vertical sectional view illustrating an example of the frozen food according to the present invention, which contains chunks of frozen soup in a tray and is packaged in a bag.

FIG. 3 is a vertical sectional view illustrating an example of the frozen food according to the present invention, contained in a food container.

FIG. 4(A) is a plan view illustrating an example of the tray for the chunks of soup.

FIG. 4(B) is a side view illustrating an example of the tray for the chunks of soup.

FIG. 5 is a vertical sectional view illustrating an example of a frozen soup in which the chunks of soup are connected to each other in a plane.

FIG. 6 is a vertical sectional view illustrating an example of the frozen soups containing small ingredients in the tray.

FIG. 7(A) is a vertical sectional view for explaining an example of the frozen food according to the present invention.

FIG. 7(B) is a vertical sectional view for explaining the example of the frozen food according to the present invention put into a microwave oven.

FIG. 7(C) is a vertical sectional view for explaining the example of the frozen food according to the present invention at the time of eating.

FIG. 8(A) is a vertical sectional view for explaining an example of the frozen food according to the present invention.

FIG. 8(B) is a vertical sectional view for explaining the example of the frozen food according to the present invention put into a microwave oven.

FIG. 8(C) is a vertical sectional view for explaining the example of the frozen food according to the present invention at the time of eating.

FIG. 9 is a photograph taken from above of the food container containing a frozen noodle and frozen ingredients.

FIG. 10 is a photograph taken from above of the chunks of frozen soup in the tray.

FIG. 11 is a photograph of a state that the chunks of the soup in FIG. 10 are taken out from the tray and placed above the frozen noodle and the frozen ingredients in FIG. 9, which was taken while a lid was not put on the container before putting the container into the microwave oven.

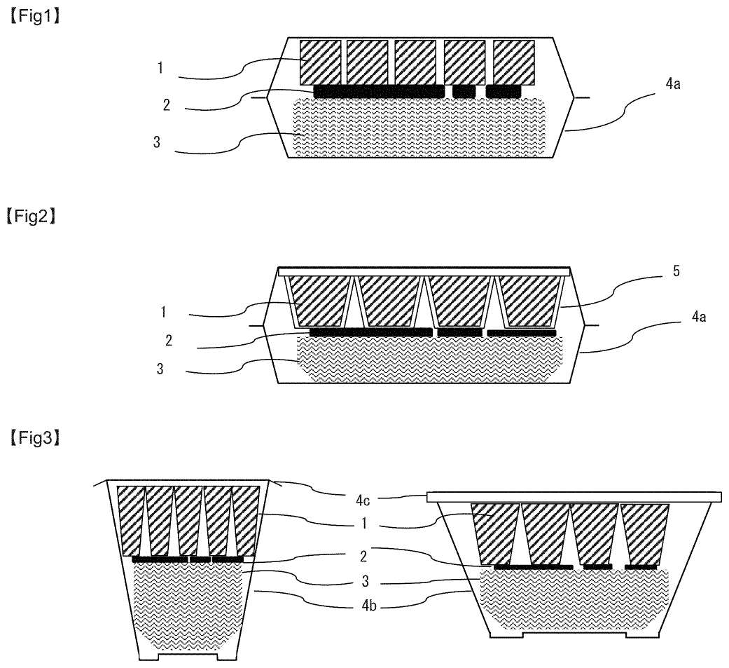

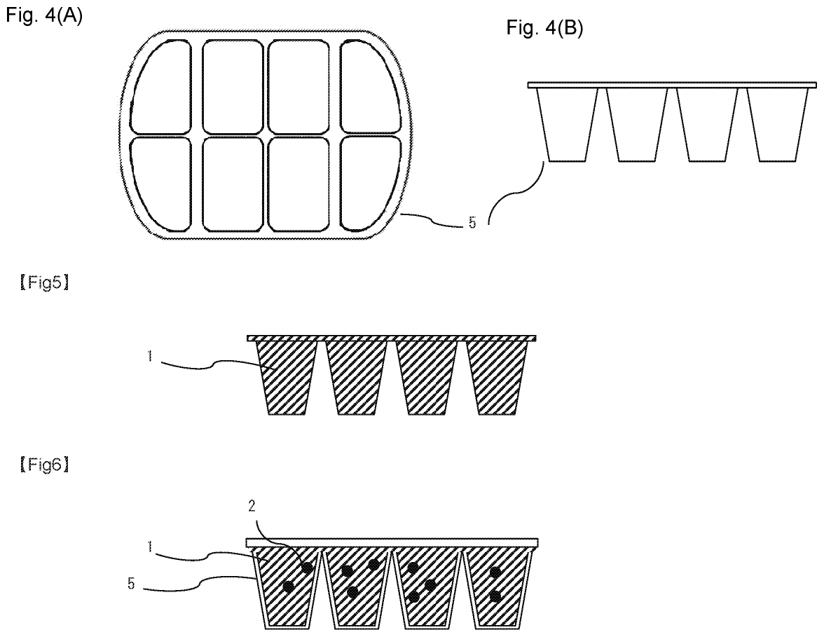

### DESCRIPTION OF EMBODIMENTS

The frozen food according to the present invention refers to a frozen food prepared by freezing a cooked food that is eatable before freezing, which is eaten by placing a plurality of chunks of frozen soup having a specific size above the frozen noodle and heating them in the microwave oven. This frozen food for microwave cooking can be deliciously eaten as a hot noodle in a simple manner by melting and heating the frozen food through microwave cooking.

The frozen noodle according to the present invention is not particularly limited as long as starch has been pregelatinized by boiling, steaming, or the like so that the noodle can be eaten by thawing. The raw materials for the noodle can be exemplified by wheat flour, rice flour, buckwheat flour, or the like. The noodle can be exemplified by Chinese noodle, udon noodle, hiyamugi noodle, somen noodle, soba noodle, pasta, rice vermicelli, pho noodle, or the like, that have been pregelatinized. The noodle may be any frozen noodle that has been pregelatinized and then frozen.

The frozen food according to the present invention may contain frozen ingredients. Any ingredients suitable for the noodle and soup can be appropriately used as the frozen ingredients. The ingredients may be frozen and placed above the frozen noodle or the frozen soup. Alternatively, the ingredients may be placed on the top of the noodle and frozen integrally with the noodle into a frozen product. Alternatively, the ingredients may be put in or on the soup and frozen integrally with the soup into a frozen product.

The chunks of frozen soup according to the present invention are not particularly limited as long as it is non-dilution type liquid soup that is typically used for noodles and frozen in chunks. The soup can be exemplified by soup of soy sauce flavor, miso flavor, pork bone flavor, salt flavor, Chinese flavor, consomme flavor, seafood flavor, vegetable flavor, etc., cream soup, broth soup, soup for Japanese noodles, or the like. Soup that does not become liquid even by thawing, and a sauce like meat sauce that is topped on pasta are unsuitable for the chunks of frozen soup according to the present invention. The soup is not particularly limited as long as the soup is not concentrated and can be used without dilution. A salt content of the soup is preferably 7% by weight or less, more preferably 0.3 to 6% by weight, even more preferably 0.5 to 5% by weight. A water content is preferably 70% by weight or more, more preferably 75% by weight or more, even more preferably 80% by weight or more. An oil content of the soup is preferably 20% by weight or less, more preferably 15% by weight or less, even more preferably 10% by weight or less. A viscosity of the soup at 20° C. is preferably 1.8 Pa·s or less, more preferably 1.6 Pa·s or less, even more preferably 1.4 Pa·s or less, particularly preferably 1.0 Pa·s or less. Since the soup is of non-dilution type, there is no loss of the aromatic components due to concentration, and the soup can be provided in a quality equivalent to the soup provided in a specialty restaurant. Thus, the soup preserves the aromatic components, and smells good and also tastes good at the time of eating. In addition, the soup can be eaten only by microwave cooking because it does not require addition of water at the time of eating. Furthermore, the soup is hard to melt during transportation at normal temperature because of a salt content lower than that of concentration type soup.

In a case that a liquid soup containing oil/fat is prepared at the time of eating, the frozen soup may be prepared by freezing soup compounded with oil/fat into chunks, or prepared by sprinkling oil/fat over the pregelatinized noodle before or after freezing and then freezing them.

Each of the chunks of frozen soup according to the present invention weighs 5 g or more and 80 g or less, preferably 10 g or more and 70 g or less, more preferably 15 g or more and 60 g or less. The shape of the soup is not particularly limited as long as the soup is frozen into chunks, and the shape of the soup can be exemplified by: a cylindrical shape, a triangular prism shape, a quadrangular prism shape, etc.; a columnar shape having a bottom face of circle, polygon, heart shape, star shape, fan shape, etc.; a spherical shape; a hemispherical shape; a cone shape; a triangular pyramid shape; a quadrangular pyramid shape; a truncated cone shape; a truncated triangular pyramid shape; a truncated quadrangular pyramid shape; a wedge shape; and the like. The soup may be frozen into the above shapes using a mold such as a tray, or may be shaped into the above shapes after freezing. The soup is preferably formed into the quadrangular pyramid shape. If the weight of each chunk is 5 g or more and 80 g or less, a height (thickness) of the column or the like is preferably larger than 5 mm, more preferably 7 mm or more and 70 mm or less, even more preferably 10 mm or more and 65 mm or less, particularly preferably 12 mm or more and 60 mm or less. If the weight of each chunk is 5 g or more and 80 g or less, a shorter side or a diameter of the bottom face of the column or the like is preferably 18 mm or more and 70 mm or less, more preferably 20 mm or more and 65 mm or less, even more preferably 22 mm or more and 60 mm or less. If each chunk is less than 5 g or has a thin and flat shape such as a flake shape, that is unfavorable because the chunks are easy to melt so that they begin to melt while being transferred to a consumer's house after purchase of the frozen food, and thus an appearance, a texture, or the like of the noodle is adversely affected, and additionally, when the chunks are refrozen after a certain time at normal temperature, the chunks adhere to each other into one large chunk, which hardly melts by microwave cooking. If each chunk is greater than 80 g, this is unsuitable because the chunks are too large to melt by heating, and uneven heating tends to occur. As long as the weight of each chunk is 5 g or more and 80 g or less, the frozen soup may have e.g., the shape as illustrated in FIG. 5 in which the upper portions of the chunks of soup are connected to each other in a plane, by pouring the soup in an amount exceeding a level of a partition of the tray and then freezing it. A thickness of the connected portion is preferably 10 mm or less, more preferably 7 mm or less, even more preferably 5 mm or less, particularly preferably 3 mm or less. It is preferable that the connected portion is broken at the time of microwave cooking and the chunks are placed on the frozen noodle. For example, as illustrated in FIG. 6, the frozen soup may contain small ingredients such as chopped green onion, crunchy bits of fried dough, sesame, pepper, and red pepper with seven kinds of spices, with a diameter of about 0.5 to 10 mm.

The number of the chunks of frozen soup of 5 g or more and 80 g or less per chunk can be appropriately determined as long as the amount of the soup is sufficient to soak the noodle in the melted liquid soup at the time of eating. For example, the number may be 3 to 60, preferably 4 to 40, more preferably 5 to 20. The total weight of the soup is preferably 0.8 to 3.0 times, more preferably 1.0 to 2.8 times, even more preferably 1.2 to 2.5 times the weight of the noodle. Depending on the weight of the noodle, for example, the number of the chunks to be used should be determined such that the total amount of the soup after melting is preferably 100 to 600 g, more preferably 150 to 500 g, even more preferably 200 to 400 g. By using the plurality of chunks of frozen soup the whole soup can be easily melt by the microwave cooking so as to prevent uneven heating.

In the cooking method according to the present invention, it is only necessary that the plurality of aforementioned chunks of frozen soup are placed above the frozen noodle and the frozen food is heated in a microwave oven. The phrase “placing above the frozen noodle” only refers to placing at a higher position with respect to the frozen noodle, and it is preferable that, at the time of microwave cooking, the frozen soup is in contact with the frozen noodle or in contact with the ingredients when the ingredients are on the frozen noodle. By the microwave cooking, the frozen food is heated while the melted soup flows down from above the noodle, so that the whole food is quickly and evenly melted and heated only by the microwave cooking, and can be eaten deliciously as a hot noodle. If the frozen noodle is placed at a higher position with respect to the chunks of frozen soup, this is unsuitable because the liquid does not cover the top of the noodle until the end of heating, and the frozen noodle is hard to melt.

The frozen food may be packaged with e.g., a bag as illustrated in FIG. 1 or e.g., a food container as illustrated in FIG. 3 that can serve as a substitute for tableware as long as it can be entirely packaged with a freeze-resistant packaging material. For example, the container may be further packaged with a bag, or shrink-packaged or partially shrink-packaged. The frozen noodle may be packaged with a bag, and a plurality of chunks of frozen soup may be packaged with one bag. When the frozen food contains ingredients, the ingredients may be packaged, or the frozen noodle and the ingredients may be integrally frozen and packaged as a frozen product. The chunks of frozen soup in the tray may be used together with the tray. When using the tray, a top-sealed frozen food is preferable. Thereby, it is possible to prevent splash of the soup during freezing, contamination due to foreign substances, and liquid leakage due to dissolution of the soup during transportation. A frozen food in a food container, in which the frozen noodle, the ingredients, and the plurality of chunks of frozen soup of 5 g or more and 80 g or less per chunk are arranged in this order from the bottom, is preferable. When the frozen noodle and the chunks of frozen soup are arranged in contact with each other in the packaged product, and the soup contains oil/fat, it is preferable that the frozen food is packaged so that the surface of the oil/fat is in contact with the frozen noodle because the chunks are difficult to adhere to it even if the surface of the soup is once melted and then refrozen. When the chunks of frozen soup in the tray and the food container are used, they can be arranged in such a way that the bottom of the tray is directed downward, and an edge of the soup tray is fitted into an edge of the food container. In this case, the frozen noodle and the tray do not have to be in contact with each other, but it is preferable that the gap therebetween is small, and it is more preferable that they are in contact with each other. The food container that can serve as a substitute for tableware is a freeze-resistant and heat-resistant container and is preferably equipped with a lid. The lid may be a bonded or heat-sealed sheet-shaped lid, but a fitting lid is preferable.

The frozen food according to the present invention comprises a frozen noodle and soup prepared by freezing non-dilution type liquid soup into chunks, and preferably further comprises ingredients. The frozen food is not particularly limited as long as the food can be deliciously eaten in a simple manner as a normal hot noodle in which the noodle is present in the liquid soup, by melting and heating the frozen food through microwave cooking. The frozen food can be exemplified by Chinese noodle, udon noodle, soba noodle, soup pasta, or the like, and above all, Chinese noodle is preferable.

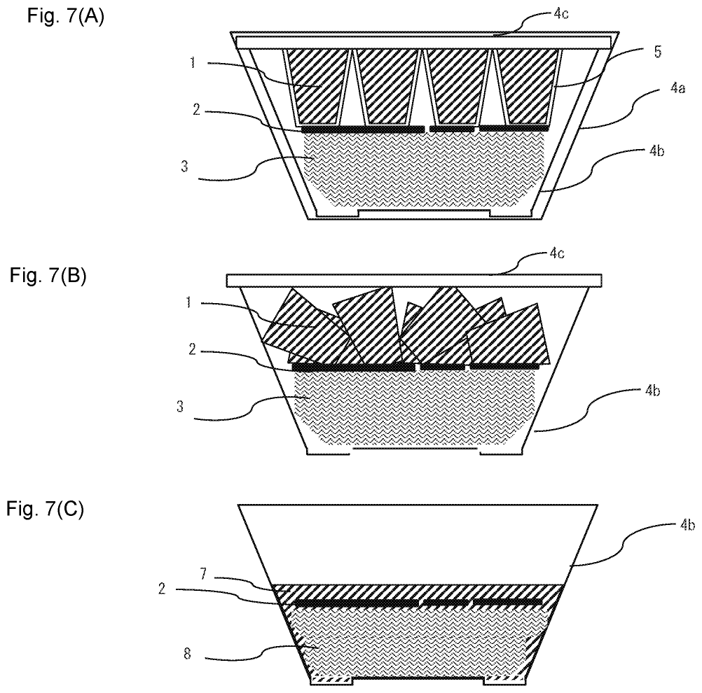

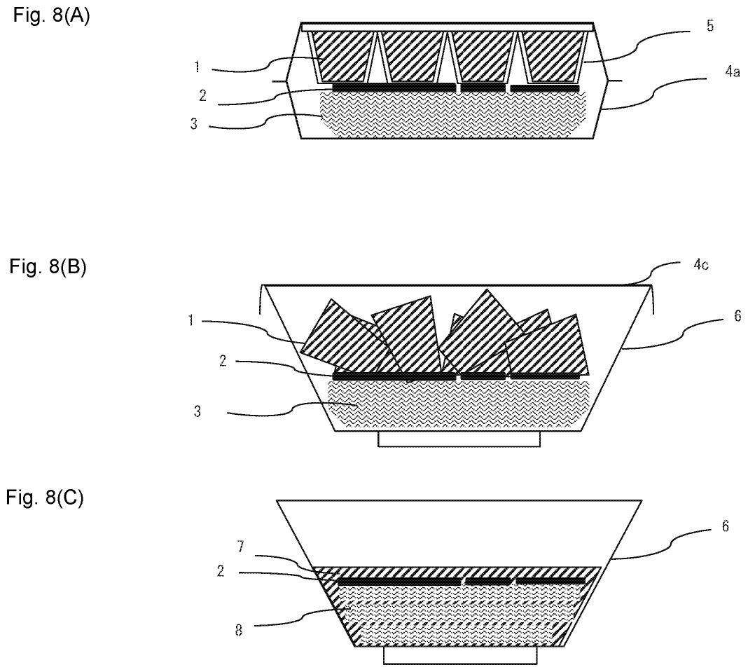

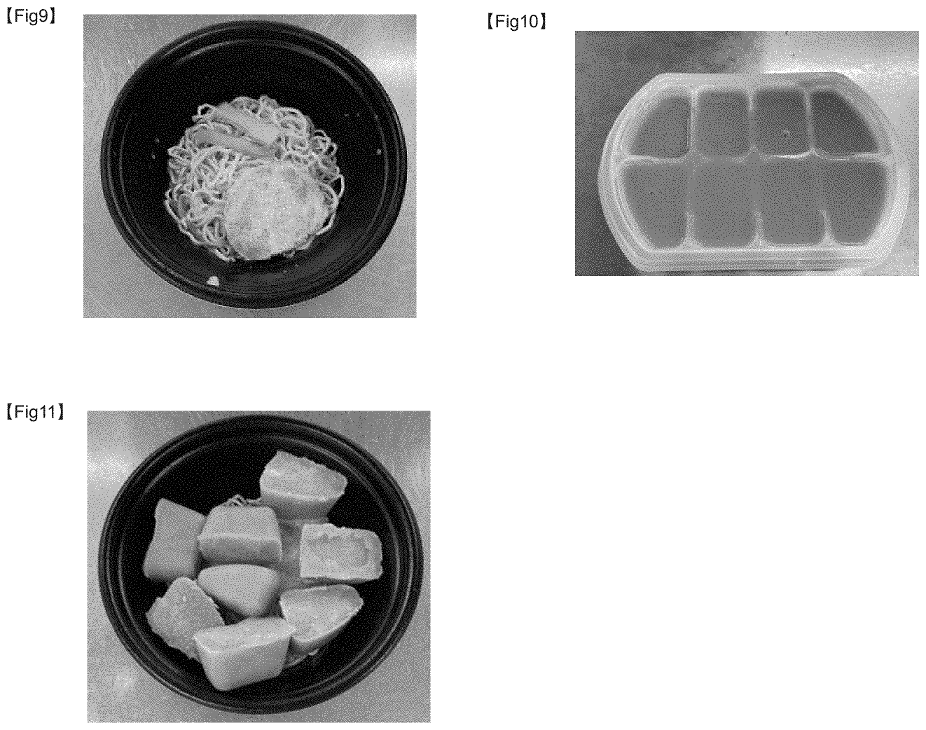

If there is a tray or a package other than the food container, the tray or package is removed at the time of eating, a tableware is prepared as necessary, and the frozen noodle and the plurality of chunks of frozen soup are placed in this order from the bottom of the food container or the tableware. If the ingredients are separately comprised, the ingredients only need to be placed at a higher position with respect to the frozen noodle, and it is preferable that the ingredients are present between the frozen noodle and the frozen soup or in the frozen soup. The respective components are arranged in the food container or the tableware as described above, which is covered with a lid and then put into a microwave oven. Subsequently, the frozen food should be cooked by heating to such an extent that the frozen food melts and can be eaten as a hot noodle, and then eaten. A heating time can be appropriately set depending on an amount of the soup and a type of the noodle, and should be set such that the whole product melts without uneven heating and a temperature and a texture of the noodle that are optimal for eating are obtained. When the frozen soup is composed of the connected chunks of soup, the soup may be taken out from the tray and placed directly on the frozen noodle at the time of eating, but it is preferable that the connected portions are broken, then the chunks are placed on the frozen noodle and the frozen noodle and the chunks are heated in the microwave oven. As illustrated in FIG. 7(A), the frozen food can be exemplified by a frozen food that is constructed by putting the frozen noodle, the ingredients, and the chunks of frozen soup in the tray into a container that can serve as a substitute for tableware, and further shrink-packaging the container. At the time of eating, for example as illustrated in FIG. 7(B), the chunks of frozen soup taken out from the tray are placed on the frozen noodle and the ingredients, which is covered by the lid. The frozen food is heated in the microwave oven so as to reach an optimum temperature and achieve an optimum texture of the noodle, and then the melted noodle soaked in the liquid soup as illustrated in FIG. 7(C) can be eaten. Furthermore, for example, as illustrated in FIG. 8(A), the frozen food can be exemplified by a frozen food constructed by packaging the frozen noodle, the ingredients, and the chunks of frozen soup in a bag. At the time of eating, for example, as illustrated in FIG. 8(B), the frozen noodle and the ingredients are put into a prepared tableware, on which the chunks of frozen soup taken out from the tray are placed, and the tableware is covered with plastic wrap or the like. Subsequently, the frozen food is heated in the microwave oven so as to reach an optimum temperature and achieve an optimum texture of the noodle, and then the melted noodle soaked in the liquid soup as illustrated in FIG. 8(C) can be eaten.

### EXAMPLES

Although the present invention now will be specifically explained below with reference to Examples, the present invention is not limited by the following examples. Note that “%” is all “% by weight” in the present invention unless otherwise indicated.

### Example 1

210 g of Chinese noodle soup (water content: 85.8%, salt content: 3.03%, oil content: 4%, Brix: 15.5%, viscosity (20° C.): 0.38 Pa·s) was heated for about 30 minutes. After the temperature reached 90° C., the soup was poured into six trays having a top size of 44.2 mm×41.9 mm, a bottom size of 42.2 mm×39.9 mm, and a height of 20.5 mm, and frozen at −40° C. for 30 minutes to obtain six chunks of frozen soup of about 35 g per chunk.

A thick noodle (manufactured by IWASAKI FOODS CO., LTD) was boiled in boiling water for 1 minute and soaked in cold water for about 10 seconds to roughly reduce the heat. Then, 150 g of the boiled noodle was put into a circular tray having a top diameter of 140 mm, a bottom diameter of 120 mm, and a height of 25 mm, on which roast pork, green onion, and boiled bamboo shoots as ingredients were placed. The noodle and the ingredients were frozen at −40° C. for 30 minutes to obtain a frozen product of the integrated boiled noodle and ingredients.

The frozen product was put into a food container, on which the six chunks of frozen soup were placed. The frozen product ant the chunks of soup were frozen at −40° C. for 30 minutes to obtain a frozen Chinese noodle in a food container.

### Comparative Example 1

A commercially available frozen Chinese noodle (manufactured by KINREI CORPORATION), which can be eaten by being heated in a pot and then transferred to another container, was taken out from a packaging bag and put in a food container to obtain a frozen Chinese noodle in a food container. The frozen food had an overall composition that a disc-shaped frozen soup, a disc-shaped frozen noodle having the same diameter as of the soup, and ingredients (roast pork, green onion, and boiled bamboo shoots) were integrated in this order from the bottom.

### Comparative Example 2

210 g of the same Chinese noodle soup as in Example 1 was heated for about 30 minutes, and after the temperature reached 90° C., the soup was allowed to stand until it cooled down.

A thick noodle (manufactured by IWASAKIFOODS CO., LTD) was boiled in boiling water for 1 minute and soaked in cold water for about 10 seconds to roughly reduce the heat. Then, 150 g of the boiled noodle was put into a circular tray having a diameter of 140 mm and a height of 40 mm, on which roast pork, green onion, and boiled bamboo shoots as ingredients were placed. The noodle and the ingredients were frozen at −40° C. for 30 minutes to obtain a frozen product of the integrated boiled noodle and ingredients.

210 g of the Chinese noodle soup was poured into the circular tray containing the frozen product. The soup and the frozen product were frozen at −40° C. for 30 minutes to integrally freeze the soup, the boiled noodle, and the ingredients, and then put into a food container to obtain a frozen Chinese noodle in a food container.

### Comparative Example 3

210 g of the same Chinese noodle soup as in Example 1 was heated for about 30 minutes. After the temperature reached 90° C., the soup was put into the circular tray described in Example 1 and frozen at −40° C. for 30 minutes to obtain a disc-shaped frozen soup.

A thick noodle (manufactured by IWASAKIFOODS CO., LTD) was boiled in boiling water for 1 minute and soaked in cold water for about 10 seconds to roughly reduce the heat. Then, 150 g of the boiled noodle was put into a circular tray described in Example 1, on which roast pork, green onion, and boiled bamboo shoots as ingredients were placed. The noodle and the ingredients were frozen at −40° C. for 30 minutes to obtain a frozen product of the integrated boiled noodle and ingredients.

The frozen product was put into a food container, on which the disc-shaped frozen soup was placed. The the frozen product and the soup were frozen at −40° C. for 30 minutes to obtain a frozen Chinese noodle in the food container.

### Comparative Example 4

Six chunks of frozen soup described in Example 1 were put into a food container, on which the frozen product of the integrated boiled noodle and ingredients described in Example 1 was placed. The soup and the frozen product were frozen at −40° C. for 30 minutes to obtain a frozen Chinese noodle in the food container.

### [Evaluation Test 1]

Each frozen Chinese noodle in the food container, obtained in Example 1 and Comparative Examples 1 to 4, was heated in a microwave oven at 600 W for 6 minutes, and then subjected to a sensory evaluation. The weights of the noodles, the weights of the soup, and the compositions were summarized in Table 1. As the evaluation results, a sample with commercial value was marked by “∘”, and a sample without commercial value was marked by “x” in Table 1, and the details were also described. Note that a sample that did not thoroughly melt in 6 minutes was not subjected to the sensory evaluation at that time, but the product was heated until thoroughly melted and then subjected to the sensory evaluation, and the heating time and evaluation results were described in Table 1.

TABLE 1

| | | Comparative | | | |
|---|---|---|---|---|---|
| | | Example 1 | Comparative | Comparative | Comparative |
| | Example 1 | Commercially | Example 2 | Example 3 | Example 4 |
| | Test product of | available frozen | Test product of | Test product of | Test product of |
| | our company | Chinese noodle | our company | our company | our company |
| Weight of | 150 g | 150 g | 150 g | 150 g | 150 g |
| noodle | | | | | |
| Weight of | 210g | 330 g | 210 g | 210 g | 210 g |
| soup | | | | | |
| Composition | The six chunks of | The disc-shaped | The boiled noodle and | The disc-shaped frozen | The frozen product of |
| | frozen soup were | frozen soup having | ingredients were | soup having the same | the integrated boiled |
| | placed on the frozen | the same diameter as | contained in the soup, | diameter as of the | noodle and ingredients |
| | product of the | of the noodle, the | and they were | noodle was placed on | was placed on the six |
| | integrated boiled | frozen noodle, and the | integrally frozen. | the frozen product of | chunks of frozen soup. |
| | noodle and | ingredients, in this | | the integrated boiled | |
| | ingredients. | order from the | | noodle and ingredients. | |
| | | bottom, were | | | |
| | | integrally frozen. | | | |
| Microwave | ○ | — | — | — | — |
| cooking at | The sample | The ingredients | The ingredients | The ingredients melted, | The soup and |
| 600 W for 6 | thoroughly melted | melted, but the soup | melted, but the soup | but the soup and | ingredients melted, but |
| minutes | without uneven | and noodle did not | and noodle did not | noodle did not | the noodle did not |
| | heating, the | thoroughly melt. | thoroughly melt. | thoroughly melt. | thoroughly melt. |
| | temperature and the | | | | |
| | texture of the noodle | | | | |
| | were optimal for | | | | |
| | eating, and the soup | | | | |
| | was aromatic. The | | | | |
| | sample had an | | | | |
| | authentic taste. | | | | |
| | — | x | x | x | x |
| Microwave | — | The sample | The sample | The sample thoroughly | The sample |
| cooking at | | thoroughly melted in | thoroughly melted in | melted in 10 minutes | thoroughly melted in 9 |
| 600 W until | | 10 minutes and the | 8 minutes and the | and the soup was | minutes and the soup |
| thoroughly | | soup was aromatic, | soup was aromatic, | aromatic, but the | was aromatic, but the |
| melted | | but the noodle had | but the noodle | noodle had loosened | noodle in the top face |
| | | loosened portions and | loosened and the | portions and hard | was somewhat hard, |
| | | hard portions, causing | noodle itself absorbed | portions, causing | causing uneven |
| | | uneven texture. The | the soup and | uneven texture. The | texture. The sample |
| | | sample did not taste | discolored into | sample did not taste | did not taste good. |
| | | good. | brown. The sample | good. | |
| | | | did not taste good. | | |

As can be seen from Table 1, when the plurality of chunks of frozen soup were placed at a higher position with respect to the noodle, the sample could be deliciously eaten by the microwave cooking, and it was possible to enjoy an aromatic and authentic taste. On the other hand, the sample using the disc-shaped frozen soup, and the sample with the boiled noodle contained in the soup were both thoroughly melted by extending the heating time. However, uneven texture of the noodle attributed to the uneven heating, and loosening and discoloration of the noodle attributed to permeation of the soup into the noodle were caused, and the samples were hard to deliciously eat by microwave cooking. In addition, even if the plurality of chunks of frozen soup were used, it was difficult to deliciously eat the sample by the microwave cooking when the soup was placed on the bottom layer.

From the above, it was found that it was easy to enjoy an aromatic and authentic taste by placing the plurality of chunks of frozen soup at a higher position with respect to the noodle and heating them in a microwave oven.

### Test Example

210 g of Chinese noodle soup was heated for about 30 minutes. After the temperature reached 90° C., the soup was poured into each tray listed in Table 2 and frozen at −40° C. for 30 minutes to obtain chunks of frozen soup having each size and each number listed in Table 2.

The frozen product of the integrated boiled noodle and ingredients frozen in the same manner as in Example 1 was put into a food container, on which the chunks of frozen soup were placed. The frozen product and the soup were frozen at −40° C. for 30 minutes to obtain each frozen Chinese noodle in the food container of Test Examples 1 to 7.

TABLE 2

| | Test Example 1 | Test Example 2 | Test Example 3 | Test Example 4 |
|---|---|---|---|---|
| Size of tray top face | 20.8 mm × 20.8 mm | 29.5 mm × 29.5 mm | 35.0 mm × 30.0 mm | 44.2 mm × 41.9 mm |
| Size of tray bottom face | 16.0 mm × 16.0 mm | 24.5 mm × 24.5 mm | 30.0 mm × 24.0 mm | 42.2 mm × 39.9 mm |
| Height of tray | 10.0 mm | 14.5 mm | 20.0 mm | 20.5 mm |
| Size of a chunk of | About 3.3 g | About 11.5 g | About 15 g | About 35 g |
| frozen soup | | | | |
| Number of chunks | 64 pieces | 18 pieces | 14 pieces | 6 pieces |
| of frozen soup | | | | |

| | Test Example 5 | Test Example 6 | Test Example 7 |
|---|---|---|---|
| Size of tray top face | 51.3 mm × 42.6 mm | 60.4 mm × 44.2 mm | 87.0 mm × 71.0 mm |
| Size of tray bottom face | 47.4 mm × 38.7 mm | 56.4 mm × 40.2 mm | 83.0 mm × 67.0 mm |
| Height of tray | 22.0 mm | 21.5 mm | 22.0 mm |
| Size of a chunk of | About 42 g | About 52 g | About 105 g |
| frozen soup | | | |
| Number of chunks | 5 pieces | 4 pieces | 2 pieces |
| of frozen soup | | | |

### [Evaluation Test 2]

The frozen Chinese noodles in the food containers of Test Examples 1 to 4 were shaken at about 30 times/min at 25° C. for 40 minutes to verify influence of the transportation environment after purchase of the frozen Chinese noodle.

As a result, Test Example 2 to 4 showed no change, whereas in Test Example 1 using the chunks of frozen soup of about 3.3 g per chunk, the soup partially melted, and it was found that the soup in Test Example 1 tended to melt at normal temperature.

Also, a test in which the frozen Chinese noodles in the food containers were allowed to stand at 35° C. for 30 minutes and then vibration was applied to the side faces was conducted, and the same result as mentioned above was obtained.

### [Evaluation Test 3]

The frozen Chinese noodles of Test Examples 5 to 7 were evaluated in the same manner as in Evaluation Test 1. Since all of the samples did not thoroughly melt after heating at 600 W for 6 minutes, the samples were heated until thoroughly melted and then subjected to the sensory evaluation. Their heating times and evaluation results were described in Table 3.

TABLE 3

| | Test Example 5 | Test Example 6 | Test Example 7 |
|---|---|---|---|
| Microwave | ○ | ○ | x |
| cooking at | The sample | The sample | The sample |
| 600 W until | thoroughly melted | thoroughly melted | thoroughly melted |
| thoroughly | without uneven | without uneven | without uneven |
| melting | heating in 7 | heating in 8 | heating in 9 |
| | minutes, the | minutes, the | minutes, and the |
| | temperature and the | temperature was | soup was aromatic, |
| | texture of the | optimal for eating, | but the noodle |
| | noodle were | the noodle was | wholly loosened. |
| | optimal for eating, | somewhat soft but | The sample did not |
| | and the soup was | chewy, and the | taste good. |
| | aromatic. The | soup was aromatic. | |
| | sample had a | The sample had a | |
| | restaurant's taste. | restaurant's taste. | |

As can be seen from Table 3, in Test Examples 5 and 6 using five or four chunks of frozen soup of about 42 g or about 52 g per chunk, by extending the heating time compared to Example 1, the sample melted without uneven heating and was possible to deliciously eat by microwave cooking, and it was possible to enjoy an aromatic and authentic taste. On the other hand, in Test Example 7 using two chunks of frozen soup of 105 g per chunk, the sample was difficult to deliciously eat by microwave cooking.

From the above, it was found that when using chunks of frozen soup of about 11 to 52 g per chunk, the frozen food is not easily affected by exposure of normal temperature after purchase and can be eaten with an aromatic and authentic taste by microwave cooking.

### REFERENCE NUMERALS

1 Chunk of frozen soup
2 Frozen ingredients
3 Frozen boiled noodle
4a Bag
4b Food container
4c Lid
5 Tray
6 Tableware
7 Liquid soup
8 Melted noodle

1. A frozen food for microwave cooking, wherein a plurality of chunks of frozen soup of 5 g or more and 80 g or less per chunk are placed above a frozen noodle and wherein the frozen food is heated in a microwave oven for eating.

2. The frozen food according to claim 1, which is a frozen food in a food container wherein the plurality of chunks of frozen soup of 5 g or more and 80 g or less per chunk are arranged above the frozen noodle.

3. The frozen food according to claim 1, wherein the soup is non-concentrated soup.

4. The frozen food according to claim 1, wherein the soup has an oil content of 20% by weight or less.

5. The frozen food according to claim 1, wherein the soup has a viscosity of 1.8 Pa·s or lower at 20° C.

6. The frozen food according to claim 1, which can be eaten as a hot noodle without uneven heating by microwave cooking.

7. A method for eating a frozen food, comprising:
placing a plurality of chunks of frozen soup of 5 g or more and 80 g or less per chunk above a frozen noodle; and
heating them in a microwave oven to eat as a hot noodle.

8. A method for cooking a hot noodle, comprising:
placing a plurality of chunks of frozen soup of 5 g or more and 80 g or less per chunk above a frozen noodle; and
heating them in a microwave oven.
